(19) United States
(12) Patent Application Publication
(10) Pub. No.: US 2026/0019151 A1
(43) Pub. Date: Jan. 15, 2026

(54) FEEDBACK OF LINK STATUS DURING COMMNICATION PROCESS

(71) Applicant: Omattrix Ltd., Co., Santa Clara, CA (US)

(72) Inventor: Lung Kevin Law, Santa Clara, CA (US)

(73) Assignee: Omattrix Ltd., Co., Santa Clara, CA (US)

(21) Appl. No.: 19/282,791

(22) Filed: Jul. 28, 2025

(51) Int. Cl. H04B 10/079

(52) U.S. Cl. CPC H04B 10/0791; H04B 10/0793

(57) ABSTRACT

The present disclosure relates to a high-speed data communication technology, and in particular to a method for processing a data transmission anomaly in an optical module-based communication process, a signal processing device for implementing the method, and an optical module comprising the signal processing device. In some embodiments of the present disclosure, real-time monitoring of data transmission status associated with an egress direction and an ingress direction is realized inside an optical module, and in the event of a transmission anomaly, e.g., when the link involved in data transmission is in degraded status, relevant indication information is transmitted by inserting it into the data stream currently being transmitted.

### TECHNICAL FIELD

The present disclosure relates to a high-speed data communication technology, and in particular to a method for processing a data transmission anomaly in an optical module-based communication process, a signal processing device for implementing the method, and an optical module comprising the signal processing device.

### BACKGROUND

With the rapid development of Ethernet technology and coherent optical communication technology, high-speed Ethernet (e.g., 200G, 400G and above) plays an increasingly important role in data centers (DCs), high-performance computing (HPC), and artificial intelligence (AI). In these applications that require high bandwidth and high reliability, link status monitoring and fault detection are one of the essential technologies for ensuring communication stability and efficient data transmission.

### SUMMARY

One embodiment of the present disclosure relates to a signal processing device, comprising a first signal processing module, a second signal processing module, and an anomaly processing module. The first signal processing module and the second signal processing module are configured to convert an Ethernet data stream associated with an egress direction into an optical communication data stream associated with the egress direction, and convert an optical communication data stream associated with an ingress direction into an Ethernet data stream associated with the ingress direction, respectively. In the above device, the anomaly processing module is configured to, in response to a first anomaly event of data transmission associated with the egress direction, generate first indication information regarding the first anomaly event. The first indication information is inserted into one or more of the Ethernet data stream associated with the ingress direction, the Ethernet data stream associated with the egress direction, and the optical communication data stream associated with the egress direction. The anomaly processing module is configured to, in response to a second anomaly event of data transmission associated with the ingress direction, generate second indication information regarding the second anomaly event. The second indication information is inserted into one or more of the Ethernet data stream associated with the egress direction, the Ethernet data stream associated with the ingress direction, and the optical communication data stream associated with the egress direction.

Another embodiment of the present disclosure relates to an optical module, comprising the signal processing device as stated above.

Still another embodiment of the present disclosure relates to a method for processing a data transmission anomaly in an optical module-based communication process. In this method, the optical module, in response to a first anomaly event of data transmission associated with the egress direction, generates first indication information regarding the first anomaly event, and inserts the first indication information into one or more of the Ethernet data stream associated with the ingress direction, the Ethernet data stream associated with the egress direction, and the optical communication data associated with the egress direction. In addition, the optical module, in response to a second anomaly event of data transmission associated with the ingress direction, further generates second indication information regarding the second anomaly event, and inserts the second indication information into one or more of the Ethernet data stream associated with the egress direction, the Ethernet data stream associated with the ingress direction, and the optical communication data stream associated with the egress direction.

### BRIEF DESCRIPTION OF THE DRAWINGS

The above and/or other aspects and advantages of the present disclosure will become clearer and easier to understand in conjunction with the following description in various aspects of the drawings. The same or similar units in the drawings are represented by the same reference numerals. The drawings include:

FIG. 1 is a schematic diagram of point-to-point high-speed communication implemented using optical modules.

FIG. 2 is a block diagram of an optical module according to one embodiment of the present disclosure.

FIG. 3 shows the format of a service message.

FIG. 4 is a schematic diagram of transmitting first or second indication information by inserting an event message.

FIG. 5 is a schematic diagram of mapping an event message into 64B/66B blocks at the physical layer (PHY).

FIGS. 6 to 13 are schematic diagrams of processing data transmission anomalies according to a plurality of embodiments of the present disclosure.

FIG. 14 is a flowchart of a method for processing a data transmission anomaly in an optical module-based communication process according to a further embodiment of the present disclosure.

### DETAILED DESCRIPTION OF THE EMBODIMENTS

The present disclosure will be more fully described hereinafter with reference to the drawings of the exemplary embodiments of the present disclosure. However, the present disclosure may be implemented in different forms, and should not be construed as being limited only by the various embodiments provided herein. The various embodiments aim to make the present disclosure more comprehensive and complete, so that the protection scope of the present disclosure would be more fully conveyed to a person skilled in the art.

In this specification, terms such as “comprise” and “include” indicate that in addition to the units and steps directly and explicitly stated in the specification and claims, the technical solution of the present disclosure also does not exclude the circumstances where there are other units and steps that are not directly or explicitly stated.

In this specification, unless specifically stated, terms such as “first” and “second” do not indicate the sequence of the units in terms of time, space, size, and the like, but are merely used to distinguish various units.

In this specification, if A and B are not mutually exclusive, expressions such as “A or B” cover the circumstances of only A, only B, and the presence of both A and B simultaneously.

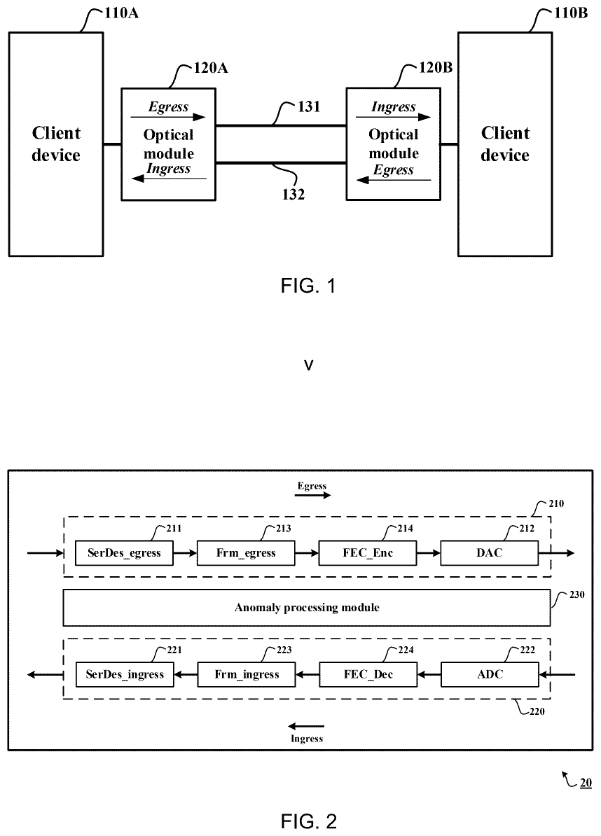

FIG. 1 is a schematic diagram of point-to-point high-speed communication implemented using optical modules. As illustrated in FIG. 1, the optical module 120A is connected to the client device 110A such as a switching device or a router via a client device-side interface (e.g., an Attachment Unit Interface (AUI interface) defined by the IEEE 802.3 standard), and is connected to optical fiber links 131 and 132 via a line-side interface (e.g., a coherent optical interface based on coherent modulation technology or an incoherent optical interface based on IM-DD technology). The optical fiber links are further connected to a line-side interface of the optical module 120B. Moreover, the optical module 120B is connected to the client device 110B via its client device-side interface. In the following description, the data transmission direction from a client device-side interface to a line-side interface and the data transmission direction from the line-side interface to the client device-side interface inside one optical module are referred to as an egress direction and an ingress direction, respectively, and the data transmission along the egress direction and the data transmission along the ingress direction inside one optical module are referred to as data transmission associated with the egress direction and data transmission associated with the ingress direction, respectively.

In the communication process where the client device 110A and the client device 110B serve as a transmitting end and a receiving end respectively, the optical module 120A encapsulates an Ethernet frame from the client device 110A into an optical communication frame and sends it to the optical module 120B via the line-side interface. In the following description, a data stream composed of a plurality of optical communication frames sent to other optical module(s) via the line-side interface is referred to as an optical communication data stream associated with the egress direction, and a data stream composed of a plurality of Ethernet frames received via the client device-side interface is referred to as an Ethernet data stream associated with the egress direction.

On the other hand, the optical module 120B receives an optical communication frame transmitted on the optical fiber link 131 via the line-side interface and decapsulates the optical communication frame to obtain an Ethernet frame, and the Ethernet frame is further transmitted to the client device 110B. In the following description, a data stream composed of optical communication frames received via the line-side interface is referred to as an optical communication data stream associated with the ingress direction, and a data stream composed of a plurality of Ethernet frames sent via the client device-side interface to the connected client device is referred to as an Ethernet data stream associated with the ingress direction.

The communication process where the client device 110B and the client device 110A serve as a transmitting end and a receiving end respectively is similar to the above-mentioned communication process, which will not be repeated here.

In the communication process illustrated in FIG. 1, taking the data transmission from the client device 110A to the client device 110B as an example, the signal transmission path includes a data link between the client device 110A and the optical module 120A, a data link in the egress direction inside the optical module 120A, the fiber optic link 131 between the optical module 120A and the optical module 120B, a data link in the ingress direction inside the optical module 120B, and a data link between the optical module 120B and the client device 110B, etc. The data link status typically includes normal status, degraded status (in which the link performance declines but can still maintain data transmission at a normal level), and fault status (in which the link is interrupted or the performance severely degrades, making data transmission unsustainable) etc.

In order to realize real-time monitoring and effective transmission of link status, an am_sf field is introduced into an alignment marker at the physical layer in high-speed Ethernet standards (such as 802. 3bs and 802. 3ck) to indicate the link status. This field is periodically embedded into the AM data block, which transmits Local Degraded (LD) information via a forward link and feeds back the Remote Degraded (RD) status via a reverse link.

Furthermore, in a data link based on coherent optical communication (e.g., the scenario defined in the OIF 400G ZR specification), an oh_sf field is defined in the link status register (CSTAT) of an optical module to transmit link status information. When an Ethernet frame is encapsulated into a ZR frame, the LD and RD information carried by the original AM will be transmitted by means of the field of CSTAT, so that the link status information can still be transmitted even after the AM is deleted.

However, since AM is inserted periodically, the real-time performance of the status information indicated by the am_sf field may be affected by a longer insertion period (e.g., tens of milliseconds to hundreds of milliseconds). In certain scenarios that require extremely high real-time performance (e.g., AI and HPC scenarios), this effect is unacceptable.

An alternative method for real-time monitoring of link status comprises setting up a dedicated microcontroller unit (MCU) inside an optical module to acquire various status data and transmitting the status data, via an I2C interface, to a FPGA module of a switching device, and then determining link status by the controller of the switching device based on the status data. In this method, the transmission and processing of status data involve multiple steps, which introduce additional communication and processing delays. Furthermore, to ensure coordinated operation of the I2C interface, MCU and FPGA, complex hardware and software design is required, resulting in increased development and maintenance costs.

In some embodiments of the present disclosure, real-time monitoring of data transmission status associated with the egress direction and the ingress direction is realized inside an optical module, and in the event of a transmission anomaly (e.g., when the link involved in data transmission is in degraded status), relevant indication information is transmitted by inserting it into the data stream currently being transmitted.

FIG. 2 is a block diagram of an optical module according to one embodiment of the present disclosure, which can be used to implement the optical modules 120A and 120B in FIG. 1. The optical module 20 illustrated in FIG. 2 comprises a first signal processing module 210, a second signal processing module 220, and an anomaly processing module 230. These modules are responsible for processing signals that carry Ethernet data streams and optical communication data streams, and can be regarded as constituent units of the components implementing signal processing functions in the optical module. In this specification, the above components for implementing signal processing functions are referred to as signal processing devices. It should be noted that for the sake of concise description, FIG. 2 does not show all components or units constituting the optical module, and those not illustrated include, for example, but are not limited to a light transmitting unit (e.g., a laser) and a light receiving unit (e.g., a photoelectric detector) etc.

In the illustrated example, the first signal processing module 210 is configured to convert an Ethernet data stream associated with the egress direction (e.g., the Ethernet data stream received by the optical module 120A from the client device 110A in FIG. 1) into an optical communication data stream associated with the egress direction (e.g., the optical communication data sent by the optical module 120A to the optical module 120B via the optical fiber link 131 in FIG. 1). The second signal processing module 620 is configured to convert an optical communication data stream associated with the ingress direction (e.g., the optical communication data stream received by the optical module 120A from the optical module 120B via the optical fiber link 132 in FIG. 1) into an Ethernet data stream associated with the ingress direction (e.g., the Ethernet data stream to be transmitted by the optical module 120A to the client device 110A in FIG. 1). The anomaly processing module 230 can be configured to monitor the data transmission associated with the egress direction, and when it is determined that a data transmission anomaly occurs, generate corresponding indication information and insert the indication information into a data stream carrying service data associated with the egress direction or the ingress direction (e.g., an Ethernet data stream associated with the ingress direction, an Ethernet data stream associated with the egress direction, and an optical communication data stream associated with the egress direction). On the other hand, the anomaly processing module 230 can also be configured to monitor the data transmission associated with the ingress direction, and when it is determined that a data transmission anomaly occurs, generate corresponding indication information and insert the indication information into a data stream carrying service data associated with the ingress direction or the egress direction (e.g., an Ethernet data stream associated with the ingress direction, an Ethernet data stream associated with the egress direction, and an optical communication data stream associated with the egress direction). It should be noted that, in this embodiment, the anomaly processing module 230 can be configured to simultaneously have the function of monitoring anomaly events in both the egress direction and the ingress direction, or it can be configured to have the function of monitoring anomaly events in only one of the two directions: either the egress direction or the ingress direction. Since both the monitoring of data transmission anomaly and the transmission of indication information are performed at the optical module, this provides a prompt response to changes in link status.

Exemplarily, the first signal processing module 210 includes a serial/parallel converter (SerDes_engress) 211 associated with the egress direction, a digital-to-analog converter (DAC) 212, a protocol processing module (Frm_engress) 213 associated with the egress direction, a forward error correction encoding module (FEC_Enc) 214, and a digital signal processing module (DSP_Tx) 215 associated with the egress direction. The serial/parallel converter 211 converts the parallel data from a client device into high-speed serial data, the digital-to-analog converter 212 converts the digital signal generated by the digital signal processing module 215 into an analog electrical signal, the protocol processing module 213 is responsible for encapsulating an Ethernet frame into an optical communication frame, the forward error correction encoding module 214 is responsible for forward error correction encoding (e.g., RS encoding) of the data generated by the protocol processing module 213, and the digital signal processing module 215 is used to perform complex algorithms such as signal distortion and noise compensation, which, for example, may assist in performing functions such as clock recovery and signal equalization to ensure reliable transmission of encoded data over the physical medium.

Exemplarily, the second signal processing module 220 includes a serial/parallel converter (SerDes_ingress) 221 associated with the ingress direction, an analog-to-digital converter (ADC) 222, a protocol processing module (Frm_ingress) 223 associated with the ingress direction, a forward error correction decoding module (FEC_Dec) 224, and a digital signal processing module (DSP_Rx) 225 associated with the ingress direction. The analog-to-digital converter 222 converts an analog electrical signal into a digital signal, the digital signal processing module 225 is used to perform complex algorithms such as signal distortion and noise compensation, the forward error correction decoding module 224 is responsible for forward error correction decoding of the data generated by the digital signal processing module 225, the protocol processing module 223 is responsible for decapsulating an optical communication frame into an Ethernet frame, and the serial/parallel converter 221 converts the high-speed serial data generated by the protocol processing module 223 into parallel data.

In the illustrated optical module, the serial/parallel converters 211 and 221, the digital-to-analog converter DAC, and the analog-to-digital converter ADC are typically implemented using dedicated hardware circuits, thus they are often referred to as physical layer interface chips.

To facilitate description, the above protocol processing modules 212 and 223, the forward error correction encoding module 214, the forward correction decoding module 224, the digital signal processing modules 215 and 225, and the anomaly processing module 230 are all presented in the form of functional modules in FIG. 2. It should be noted that these functional modules may be implemented in a variety of ways. Exemplarily, these functional modules may be implemented using hardware circuits or integrated circuit chips capable of performing the desired logic functions. The hardware circuits include, but are not limited to, an application specific integrated circuit (ASIC), a field programmable gate array (FPGA), and a digital signal processor (DSP), etc.

It should also be noted that, the above functional modules may be implemented using a single hardware circuit or an integrated circuit chip, or may be implemented by using a combination of a plurality of hardware circuits or integrated circuit chips. The latter scenario includes, but is not limited to, the following: Each functional module is implemented by a discrete integrated circuit chip; for only a portion of the functional modules, each of them is implemented by a discrete integrated circuit chip; and at least one functional module is implemented by a plurality of integrated circuit chips.

As can be seen from the above, the signal processing device comprising the first signal processing module 210, the second signal processing module 220, and the anomaly processing module 230 may be a hardware device implemented using one or more integrated circuit chips.

A data transmission anomaly in a communication process may involve status anomalies in one or more data links. Taking the optical module 120A in FIG. 1 as an example, a data transmission anomaly associated with the egress direction may be caused by the following anomalies in one or more data links: an anomaly in the data link between the client device 110A and the optical module 120A (which is manifested, for example, by an anomaly in an alignment marker of the Ethernet data stream from the client device 110A or the Ethernet data stream having a forward error correction error rate higher than a preset level) and an anomaly in the data link in the egress direction inside the optical module 120A (which is manifested, for example, by an anomaly in a physical layer interface chip (e.g., a serial/parallel converter) serving as a client-side interface), etc. On the other hand, a data transmission anomaly associated with the ingress direction may be caused by the following anomalies in one or more data links: an anomaly in the data link in the ingress direction inside the optical module 120A (which is manifested, for example, by an anomaly in a physical layer interface chip (e.g., a digital-to-analog converter or an analog-to-digital converter) serving as a line-side interface), an anomaly in the fiber optic link between the optical module 120A and the optical module 120B (which is manifested, for example, by a decrease in power or signal-to-noise ratio of an optical signal carrying an optical communication data stream from the optical module 120B, or an anomaly in an equalizer in a digital signal processing function in the ingress direction inside the optical module 120A), an anomaly in the data link in the egress direction inside the optical module 120B, and an anomaly in the data link between the optical module 120B and the client device 110B (which is manifested, for example, by the Ethernet data frame obtained by decapsulating the optical communication data frame from the optical module 120B having a forward error correction error rate higher than a preset level) etc. In the following description, an anomaly event of data transmission associated with the egress direction and an anomaly event of data transmission associated with the ingress direction are referred to as a first anomaly event and a second anomaly event, respectively. Moreover, those indicating the first anomaly event and the second anomaly event are referred to as first indication information and second indication information, respectively.

As noted above, when it is determined that a transmission anomaly occurs, an optical module (specifically the anomaly processing module 230 in this embodiment) will generate corresponding indication information and insert the indication information into an Ethernet data stream or an optical communication data stream associated with the egress direction or the ingress direction. In this embodiment, the transmission of indication information is realized by inserting a MAC message that is specifically designated to indicate a transmission anomaly into an Ethernet data stream. To differentiate from a MAC message or a service message used for transmitting service data, the MAC message used for indicating a transmission anomaly and the MAC message that will be described below to indicate transmission recovery are referred to as event messages in the following description.

In one specific example using a single integrated circuit chip to perform the functions of a protocol processing module and an anomaly processing module, the anomaly processing module can determine, based on the data received by the protocol processing module, whether a transmission anomaly occurs and instruct the protocol processing module to generate an event message. In another specific example, an anomaly processing module can determine, based on the fault warning signal of a physical layer interface chip, the occurrence of a transmission anomaly and instruct the protocol processing module to generate an event message.

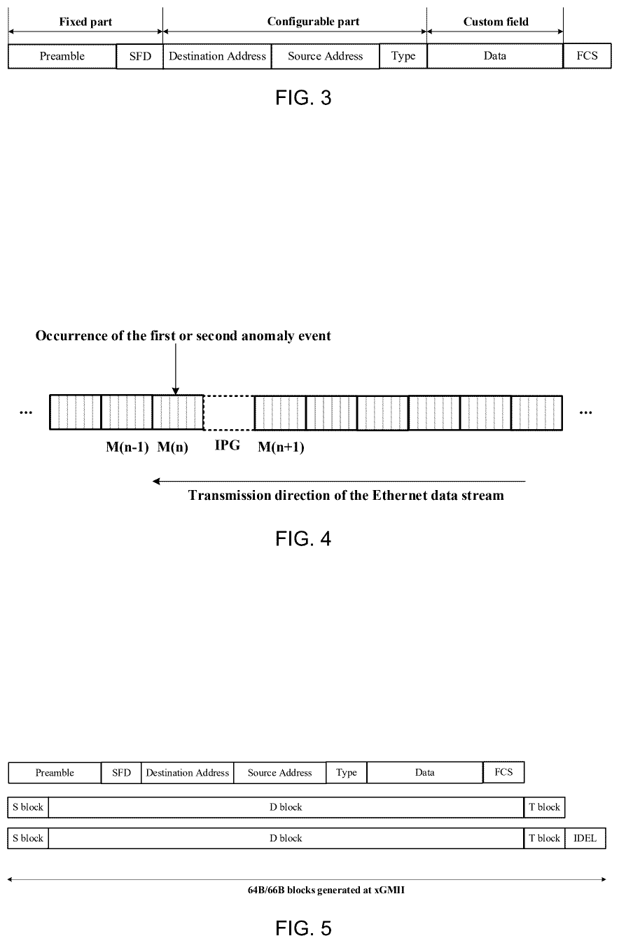

Exemplarily, the above event message may include, as illustrated in FIG. 3, a fixed part composed of fields such as Preamble and SFD, a configurable part composed of fields such as Destination MAC Address, Source MAC Address, and Type, a custom field or user-defined field DATA, and a check field FCS. Table 1 shows the descriptive information of each field and examples of length.

TABLE 1

| | Length | |
|---|---|---|
| Field | (byte) | Description |
| Preamble | 7 | Provide clock |
| | | synchronization, and indicate |
| | | the start of a signal |
| SFD (Start Frame Delimiter) | 1 | Indicate the start of a frame |
| Destination MAC Address | 6 | MAC address of the target |
| | | device |
| Source MAC Address | 6 | MAC address of the sender |
| Type | 2 | Upper-layer protocol type or |
| | | payload length |
| Data | 46~1500 | For the first or second |
| | | indication information |
| FCS(Frame Check | 4 | For error detection |
| Sequence) | | |

In the above example, the custom field DATA may be used to describe features of the first and second anomaly events in one or more dimensions, including, but not limited to: event type (e.g., an anomaly in an alignment marker in an Ethernet data stream, a decrease in power or signal-to-noise ratio of an optical signal, and an anomaly in a physical layer interface chip serving as a client-side interface), event occurrence time or event stamp, a port number assigned to the optical module involved in the anomaly event, and a parameter value involved in the anomaly event (e.g., when the type of the second anomaly event is a decrease in power or signal-to-noise ratio of an optical signal, the parameter value therein may indicate a specific value of the optical power or signal-to-noise ratio or encoded values of a numerical range). Optionally, the above custom field may be defined by a user.

Taking FIG. 1 as an example, when the anomaly processing module 230 in the optical module 120A detects a first anomaly event, it inserts first indication information in the form of an event message into an Ethernet data stream that is associated with the ingress direction and composed of a plurality of service messages, so that the event message can be sent by means of in-band signaling via an AUI interface to the client device 110A, and then the client device 110A performs corresponding processing (e.g., routing switch processing) based on the first indication information. The AUI interface directly implements the interconnection between the Ethernet switching device chip and the optical module through high-speed electrical connection without additional protocol stack processing (e.g., control messages of I2C or MDIO), thereby improving transmission efficiency and real-time performance. In addition, using a standardized interface such as AUI ensures interconnection and intercommunication between optical modules and switching chips of different manufacturers.

Still taking FIG. 1 as an example, when the anomaly processing module 230 in the optical module 120A detects a second anomaly event, it inserts second indication information in the form of an event message into an Ethernet data stream that is associated with the egress direction and composed of a plurality of service messages. The Ethernet data stream is converted into an optical communication data stream, and then sent via the optical fiber link 131 to the optical module 120B, where it is converted into an Ethernet data stream and sent to the client device 110B. Then, the client device 110B performs corresponding processing based on the second indication information.

In this embodiment, an optical module or the anomaly processing module 230 can insert one or more event messages all at once or insert a plurality of event messages periodically into an Ethernet data stream. Specifically, upon detecting the occurrence of a first or second anomaly event, it generates a corresponding event message as first or second indication information, and transmits the generated event message(s) immediately or transmits a plurality of generated event messages in a preset period of time after the service message that is currently being sent completes transmission. FIG. 4 is a schematic diagram of transmitting first or second indication information by inserting an event message, wherein the blocks with shadow lines represent one or more representative service messages that are transmitted continuously, and the dashed block represents an event message. As shown in this figure, the occurrence of a first or second anomaly event is detected during the transmission of the nth service message M(n). Thus, the generated event message IPG is inserted between the service message M(n) and the subsequent service message M(n+1). In other words, the event message is transmitted immediately after the service message M (n) completes transmission, while subsequent service messages are buffered and will resume transmission only after the event message IPG completes transmission. It should be noted that the Ethernet data stream comprising service messages as illustrated in FIG. 4 may be either associated with the ingress direction or associated with the egress direction.

From a functional perspective, in one specific example, the aforementioned insertion of the MAC message can be performed at the xGMII interface within the previously mentioned protocol processing module. Taking the 800G ZR protocol defined by OIF as an example, the corresponding implementation node is the 64B/66B encoding/decoding node. The 64B/66B module can identify the start position of a message based on the S codeword and T codeword. Specifically, upon receipt of a T Block in the format of SD . . . DT, it can be determined that the transmission of a message has been completed. During the insertion operation, the event message will be mapped into physical layer (PHY) 64B/66B blocks as illustrated in FIG. 5 in accordance with the xGMII interface specification. The illustrated 64B/66B blocks comprise S Block, Data Block, and T Block. Optionally, an IDLE Block can be further added to the end of the T Block of the 64B/66B blocks.

In a variation of this embodiment, when data transmission resumes normal operation (e.g., the first or second anomaly event no longer exists because the optical signal power or the forward error correction error rate reverts to a normal level, the operation of the physical layer interface chip resumes normal operation), the anomaly processing module 230 can generate corresponding indication information (which is referred to as third indication information in the following description) and insert the indication information into an Ethernet data stream or an optical communication data stream associated with the egress direction or the ingress direction. Likewise, the third indication information may also take the form of a MAC message, and its message format may be the same as or different from the event message as illustrated in FIG. 3.

In practical applications, since multiple optical modules may be connected onto one switching device, the above indication information needs to include the port number assigned to the optical module involved in the anomaly event, so that the switching device can determine the data transmission path where the anomaly occurs and then perform corresponding processing (e.g., closing the port connected to the optical module involved in the anomaly event, and switching the current communication to another port). In a specific example, a register may be provided within an optical module for storing the port number assigned to the optical module involved in the anomaly event. Taking the situation shown in FIG. 1 as an example, when the optical module 120A is connected to the client device 110A and the optical module 120B is connected to the client device 110B, these two modules will be assigned with corresponding port numbers PORT_A and PORT_B. The above port numbers can be manually configured by users or automatically configured by client devices. Optionally, the optical module 120A may store the assigned port number PORT_A inside its register. In addition, optionally, the optical module 120 may simultaneously store port numbers PORT_A and PORT_B inside its register.

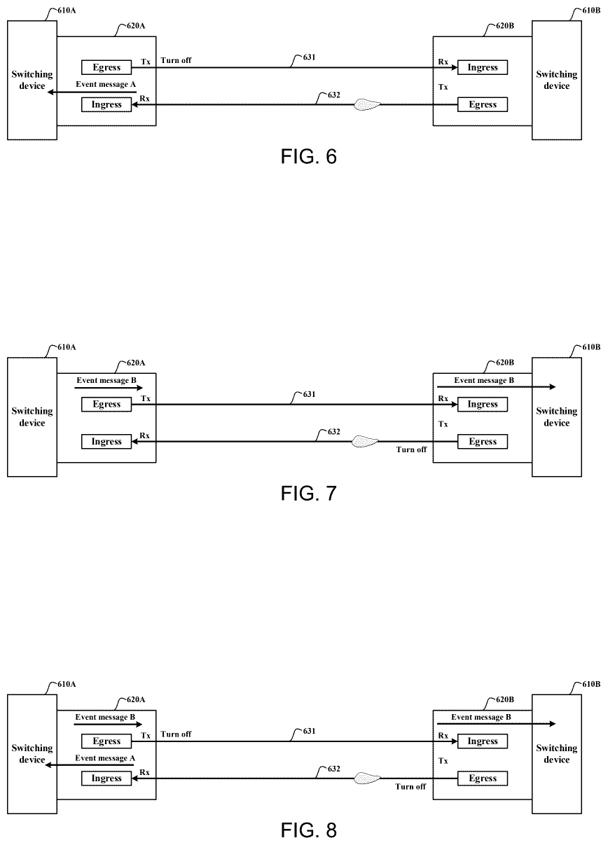

FIGS. 6 to 13 are schematic diagrams of processing data transmission anomalies according to a plurality of embodiments of the present disclosure. The communication system 50 as illustrated in the figures include switching devices 610A and 610B, optical modules 620A and 620B, and optic fiber links 631 and 632. The switching devices 610A and 610B are connected with the optical modules 620A and 620B via a connection interface (e.g., SPI interface). Exemplarily, the port numbers of the optical modules 620A and 620B connected onto the switching devices 610A and 610B can be assigned by the switching devices or the optical modules. Furthermore, the optical modules 620A and 620B are connected via the optical fiber links 631 and 632. In the illustrated plurality of embodiments, the optical modules 620A and 620B possess various features and corresponding variations of the embodiments described above with reference to FIGS. 1 to 5.

To avoid redundancy, the following description will focus on the distinguishing features between various embodiments. It should be noted that, provided that these distinguishing features do not conflict, each embodiment may incorporate features and variations thereof from other embodiments.

Referring to FIG. 6, when a fault occurs in the fiber optic link 632, the optical module 620B, or the switching device 610B, the anomaly processing module of the optical module 620A will detect a data transmission anomaly associated with the ingress direction (which belongs to the second anomaly event of data transmission associated with the ingress direction). Then, the optical module 620A sends the indication information regarding the anomaly event to the switching device 610A by inserting one event message A or inserting a plurality of event messages A in a preset period into an Ethernet data stream that is associated with the ingress direction and carrying service data. As noted above, the event type, the event occurrence time, the port number assigned to the optical module 620A, the parameter value involved in the event and the like are included in the custom field of the event message. The switching device 610A can determine, based on the port number included in the event message A, the optical module involved in the event (optical module 620A in this case), and then disable data transmission at the Tx end of the optical module 620A and perform the corresponding routing switch processing.

In the embodiment illustrated in FIG. 7, when a fault occurs in the optical fiber link 632, the optical module 620B, or the switching device 610B, the anomaly processing module of the optical module 620A will detect a data transmission anomaly associated with the ingress direction. Different from the embodiment illustrated in FIG. 6, the optical module 620A will insert one event message B or insert a plurality of event messages B in a preset period into an Ethernet data stream that is associated with the egress direction and carrying service data. The event message is encapsulated in an optical communication frame and sent via the optical fiber link 631 to the optical module 620B. Then the optical module 620B extracts the event message B from the optical communication frame and sends it to the switching device 610B. In this embodiment, the custom field of the event message B includes the event type, the event occurrence time, the port number assigned to the optical module 620B, and the parameter value involved in the event, etc. Correspondingly, the switching device 610B can determine, based on the port number included in the event message B, the optical module involved in the event (optical module 620B in this case), and disable data transmission at the Tx end of the optical module 620B and perform the corresponding routing switch processing.

Still referring to FIG. 8, when the anomaly processing module of the optical module 620A detects an anomaly in data transmission associated with the ingress direction, different from the embodiments illustrated in FIGS. 6 and 7, it on the one hand inserts one event message A or inserts a plurality of event messages A in a preset period into an Ethernet data stream that is associated with the ingress direction and carrying service data, and on the other hand inserts one event message B or a plurality of event messages B into an Ethernet data stream that is associated with the egress direction and carrying service data. In this embodiment, the custom field of the event message A includes the event type, the event occurrence time, the port number assigned to the optical module 620A, and the parameter value involved in the event, etc. The custom field of the event message B includes the event type, the event occurrence time, the port number assigned to the optical module 620B, and the parameter value involved in the event. Correspondingly, the switching device 610A, in response to the event message A, disables data transmission at the Tx end of the optical module 620A and performs the corresponding routing switch processing. The switching device 620B, in response to the event message B, disables data transmission at the Tx end of the optical module 620B and performs the corresponding routing switch processing.

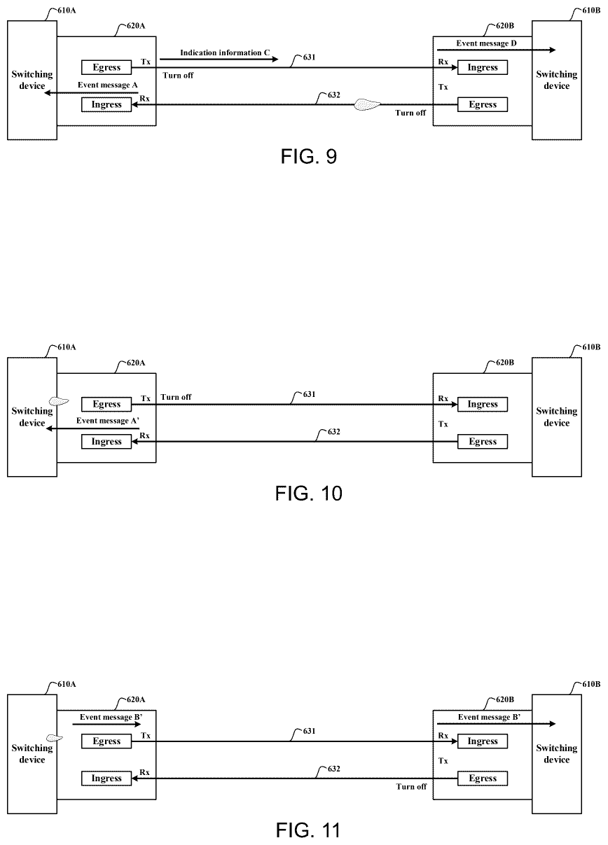

In some scenarios, for local optical modules, the port numbers of peers or remote optical modules may be unknown. In this situation, the optical module that has detected a data transmission anomaly, on the one hand, can send indication information regarding the anomaly event (e.g., as in the embodiments illustrated in FIGS. 6 and 8) in the form of an event message to a local switching device, and on the other hand can also send indication information in other forms to peers. Specifically, referring to FIG. 9, assuming that the optical communication frame transmitted between the optical module 620A and the optical module 620B includes a reserved field (e.g., the optical communication frame based on the OIF 400G/800G ZR standard), when the anomaly processing module of the optical module 620A detects an anomaly in data transmission associated with the ingress direction, it on the one hand inserts one event message A or inserts a plurality of event messages A in a preset period into an Ethernet data stream that is associated with the ingress direction and carrying service data, and on the other hand utilizes the reserved field to transmit the corresponding indication information C (this indication information does not include the port number assigned to the optical module 620B). Subsequently, when the optical module 620B detects the indication information C in the received optical communication frame, it inserts one event message D (e.g., the same as the event message B in FIGS. 7 and 8) into the Ethernet data stream that is associated with the ingress direction and carrying service data, so that the switching device 610B can determine, based on the port number included in the event message D, the optical module involved in the event, and then disable data transmission at the Tx end of the optical module 620B and perform the corresponding routing switch processing.

In the embodiments illustrated with reference to FIGS. 6 to 9, the anomaly in data transmission detected by the anomaly processing module is associated with the ingress direction, i.e., it belongs to the second anomaly event of data transmission associated with the ingress direction. The anomaly in data transmission associated with the egress direction or the first anomaly event can also be handled in a manner similar to that described above. The following provides further description with reference to FIGS. 10 to 13.

Referring to FIG. 10, when the anomaly processing event of the optical module 620A detects an anomaly in data transmission associated with the egress direction (this anomaly may be caused by, for example, a fault in a client-side physical interface chip of the optical module 620A), it sends the indication information regarding the anomaly event to the switching device 610A by inserting one event message A′ or inserting a plurality of event messages A′ in a preset period into an Ethernet data stream that is associated with the ingress direction and carrying service data. Since the event message A′ includes the port number assigned to the optical module 620A, the switching device 610A can determine the optical module involved in the event (optical module 620A in this case), and disable data transmission at the Tx end of the optical module 620A and perform the corresponding routing switch processing.

Further referring to FIG. 11, when the anomaly processing module of the optical module 620A detects an anomaly in data transmission associated with the egress direction, different from the embodiment illustrated in FIG. 10, the optical module 620A inserts one event message B′ or inserts a plurality of event messages B′ in a preset period into an Ethernet data stream that is associated with the egress direction and carrying service data. The event message is encapsulated in an optical communication frame and sent via the optical fiber link 631 to the optical module 620B. Then the optical module 620B extracts the event message B′ from the optical communication frame and sends it to the switching device 610B.

Correspondingly, the switching device 610B can determine, based on the port number included in the event message B′, the optical module involved in the event (optical module 620B in this case), and then disable data transmission at the Tx end of the optical module 620B and perform the corresponding routing switch processing.

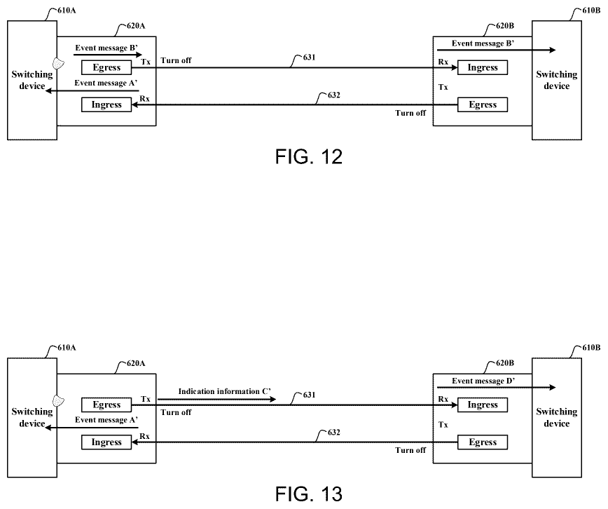

In the embodiment illustrated in FIG. 12, when the anomaly processing module of the optical module 620A detects an anomaly in data transmission associated with the egress direction, different from the embodiments illustrated in FIGS. 10 and 11, the optical module 620A on the one hand inserts one event message A′ or inserts a plurality of event messages A′ in a preset period into an Ethernet data stream that is associated with the ingress direction and carrying service data, and on the other hand inserts one event message B′ or inserts a plurality of event messages B′ in a preset period into an Ethernet data stream that is associated with the egress direction and carrying service data. In this embodiment, the event messages A′ and B′ include the port number assigned to the optical module 620A and the port number assigned to the optical module 620B, respectively. Therefore, the switching device 610A can, in response to the event message A′, disable data transmission at the Tx end of the optical module 620A and perform the corresponding routing switch processing. The switching device 610B can, in response to the event message B′, disable data transmission at the Tx end of the optical module 620B and perform the corresponding routing switch processing.

In the case where the port number of a remote optical module is unknown to a local optical module, the optical module that has detected a data transmission anomaly, on the one hand, can send indication information regarding the anomaly event (e.g., as in the embodiments illustrated in FIGS. 10 and 12) in the form of an event message to a local switching device, and on the other hand can also send indication information in other forms to peers. Specifically, referring to FIG. 13, when the anomaly processing module of the optical module 620A detects an anomaly in data transmission associated with the ingress direction, it on the one hand inserts one event message A′ or inserts a plurality of event messages A′ in a preset period into an Ethernet data stream that is associated with the ingress direction and carrying service data, and on the other hand utilizes the reserved field in the optical communication frame to transmit the corresponding indication information C′ (this indication information does not include the port number assigned to the optical module 620B). Subsequently, the optical module 620, based on the indication information C′ in the received optical communication frame, inserts one event message D′ (e.g., the same as the event message B′ in FIGS. 11 and 12) into an Ethernet data stream that is associated with the ingress direction and carrying service data, so that the switching device 610B can disable data transmission at the Tx end of the optical module 620B and perform the corresponding routing switch processing.

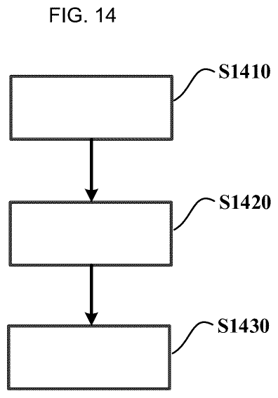

FIG. 14 is a flowchart of a method for processing a data transmission anomaly in an optical module-based communication process according to a further embodiment of the present disclosure. Exemplarily, each step of the method is performed by the optical module described above, and therefore the method includes various features and corresponding variations of the aforementioned embodiments.

The method illustrated in FIG. 14 comprises the following steps:
S1410: in response to a first anomaly event of data transmission associated with the egress direction, generating first indication information associated with the first anomaly event and inserting the first indication information into one or more of the following: an Ethernet data stream associated with the ingress direction, an Ethernet data stream associated with the egress direction, and an optical communication data stream associated with the egress direction.
S1420: in response to a second anomaly event of data transmission associated with the ingress direction, generating second indication information associated with the second anomaly event and inserting the second indication information into one or more of the following: the Ethernet data stream associated with the egress direction, an Ethernet data stream associated with the ingress direction, and an optical communication data stream associated with the egress direction;
S1430: in response to recovery of data transmission associated with the egress direction or recovery of data transmission associated with the ingress direction, generating third indication information regarding the recovery and inserting the third indication information into one or more of the following: an Ethernet data stream associated with the ingress direction, an Ethernet data stream associated with the egress direction, and an optical communication data stream associated with the egress direction.

It should be understood that the sequence of the steps S1410 to S1430 illustrated in FIG. 14 is merely exemplary, and these steps can be executed according to various time sequences (such as sequentially or in parallel). For example, step S1420 may be executed prior to step S1410, or steps S1410 and S1420 may be executed simultaneously. Moreover, in a variation of this embodiment, steps S1410 to S1430 may also be executed by choosing one step only or in partial combination. For example, only one of steps S1410 to S1430 is executed, or S1410 and S1420 are executed, or S1410 and S1430 are executed, or S1420 and S1430 are executed.

A person skilled in the art will appreciate that various illustrative logical blocks, modules, circuits, and algorithm steps described herein may be implemented as electronic hardware, computer software, or a combination of both.

To demonstrate interchangeability between hardware and software, various illustrative components, blocks, modules, circuits and steps have been described above in general terms based on their functionality. Such functionality is implemented in the form of hardware or software, depending on particular applications and design constraints imposed on the overall system. A person skilled in the art may implement the described functionality in varying ways for particular applications, but such implementation decisions should not be construed to result in a departure from the scope of the present disclosure.

While only some embodiments of the present disclosure are described, it should be understood by a person skilled in the art that the present disclosure can be implemented in various other forms without departing from its main purpose and scope. Therefore, the examples and embodiments provided are intended to be illustrative rather than restrictive, and the present disclosure may encompass various modifications and substitutions without departing from the spirit and scope of the present disclosure as defined in the appended claims.

The embodiments and examples provided herein are intended to best illustrate the embodiments in accordance with the present technology and its specific applications, thereby enabling a person skilled in the art to implement and utilize the present disclosure. However, a person skilled in the art will recognize that the foregoing description and examples are provided solely for illustrative and exemplary purposes. The description provided herein is not intended to cover various aspects of the present disclosure or to limit the present disclosure to the precise form disclosed herein.

What is claimed is:

1. A signal processing device, comprising:
a first signal processing module, configured to convert an Ethernet data stream associated with an egress direction into an optical communication data stream associated with the egress direction;
a second signal processing module, configured to convert an optical communication data stream associated with an ingress direction into an Ethernet data stream associated with the ingress direction; and
an anomaly processing module, configured to:
in response to a first anomaly event of data transmission associated with the egress direction, generate first indication information regarding the first anomaly event and insert the first indication information into one or more of the following: the Ethernet data stream associated with the ingress direction, the Ethernet data stream associated with the egress direction, and the optical communication data stream associated with the egress direction, or
in response to a second anomaly event of data transmission associated with the ingress direction, generate second indication information regarding the second anomaly event and insert the second indication information into one or more of the following: the Ethernet data stream associated with the egress direction, the Ethernet data stream associated with the ingress direction, and the optical communication data stream associated with the egress direction.

2. The signal processing device according to claim 1, wherein the first indication information and the second indication information are in the form of MAC messages, the MAC message comprising a custom field to describe features in one or more of the following dimensions: event type, event occurrence time, a port number assigned to the optical module involved in the anomaly event, and a parameter value involved in the anomaly event.

3. The signal processing device according to claim 2, wherein the custom field is defined by a switching device.

4. The signal processing device according to claim 2, wherein the anomaly processing module is configured to:
transmit the first indication information immediately or in a preset period, after completion of transmission of a current service message included in the Ethernet data stream associated with the ingress direction; or
transmit the second indication information immediately or in a preset period, after completion of transmission of a current service message included in the Ethernet data stream associated with the egress direction.

5. The signal processing device according to claim 4, wherein the anomaly processing module is configured to perform immediate transmission and transmission in a preset period of the first indication information and the second indication information in the following manner:
inserting, via an xGMII interface, the first indication information and the second indication information in the form of MAC messages into the Ethernet data stream associated with the ingress direction and the Ethernet data stream associated with the egress direction.

6. The signal processing device according to claim 2, further comprising a register configured to store the port number assigned to the optical module and a port number assigned to an optical module in point-to-point communication with the optical module.

7. The signal processing device according to claim 1, wherein the anomaly processing module is further configured to:
in response to recovery of data transmission associated with the egress direction or recovery of data transmission associated with the ingress direction, generate third indication information regarding the recovery and insert the third indication information into one or more of the following: the Ethernet data stream associated with the ingress direction, the Ethernet data stream associated with the egress direction, and the optical communication data stream associated with the egress direction.

8. The signal processing device according to claim 1, wherein the first signal processing module, the second signal processing module, and the anomaly processing module are implemented by a single integrated circuit chip or implemented by a combination of multiple integrated circuit chips.

9. The signal processing device according to claim 1, wherein the first signal processing module and the second single processing module comprise physical layer interface chips as a client-side interface and a line-side interface, and an integrated circuit chip for implementing a protocol processing function, a forward error correction function, and a digital signal processing function, wherein the integrated circuit chip for implementing the protocol processing function, the forward error correction function, and the digital signal processing function is a single integrated circuit chip or a combination of multiple integrated circuit chips.

10. The signal processing device according to claim 9, wherein the first anomaly event comprises one or more of the following: an anomaly in a physical layer interface chip serving as the client-side interface, an anomaly in an alignment marker in the Ethernet data stream associated with the egress direction, and a forward error correction error rate in the Ethernet data stream associated with the egress direction higher than a preset level.

11. The signal processing device according to claim 9, wherein the second anomaly event comprises one or more of the following: an anomaly in a physical layer interface chip serving as the line-side interface, a decrease in power or signal-to-noise ratio of an optical signal carrying the optical communication data stream associated with the ingress direction, an anomaly in an equalizer in a digital signal processing function associated with the ingress direction, and a forward error correction error rate in the Ethernet data stream associated with the ingress direction higher than a preset level.

12. The signal processing device according to claim 1, wherein the optical communication data stream is a coherent optical communication data stream.

13. An optical module, comprising a signal processing device, wherein the signal processing device comprises:
a first signal processing module, configured to convert an Ethernet data stream associated with an egress direction into an optical communication data stream associated with the egress direction;
a second signal processing module, configured to convert an optical communication data stream associated with an ingress direction into an Ethernet data stream associated with the ingress direction; and
an anomaly processing module, configured to:
in response to a first anomaly event of data transmission associated with the egress direction, generate first indication information regarding the first anomaly event and insert the first indication information into one or more of the following: the Ethernet data stream associated with the ingress direction, the Ethernet data stream associated with the egress direction, and the optical communication data stream associated with the egress direction, or
in response to a second anomaly event of data transmission associated with the ingress direction, generate second indication information regarding the second anomaly event and insert the second indication information into one or more of the following: the Ethernet data stream associated with the egress direction, the Ethernet data stream associated with the ingress direction, and the optical communication data stream associated with the egress direction.

14. The optical module according to claim 13, wherein the first indication information and the second indication information are in the form of MAC messages, the MAC message comprising a custom field to describe features in one or more of the following dimensions: event type, event occurrence time, a port number assigned to the optical module involved in the anomaly event, and a parameter value involved in the anomaly event.

15. The optical module according to claim 14, wherein the anomaly processing module is configured to:
transmit the first indication information immediately or in a preset period, after completion of transmission of the current service message included in the Ethernet data stream associated with the ingress direction; or
transmit the second indication information immediately or in a preset period, after completion of transmission of the current service message included in the Ethernet data stream associated with the egress direction.

16. The optical module according to claim 15, wherein the anomaly processing module is configured to perform immediate transmission and transmission in a preset period of the first indication information and the second indication information in the following manner: inserting, via an xGMII interface, the first indication information and the second indication information in the form of MAC messages into the Ethernet data stream associated with the ingress direction and the Ethernet data stream associated with the egress direction.

17. The optical module according to claim 13, wherein the anomaly processing module is further configured to:
in response to recovery of data transmission associated with the egress direction or recovery of data transmission associated with the ingress direction, generate third indication information regarding the recovery and insert the third indication information into one or more of the following: the Ethernet data stream associated with the ingress direction, the Ethernet data stream associated with the egress direction, and the optical communication data stream associated with the egress direction.

18. The optical module according to claim 13, wherein the first signal processing module, the second signal processing module, and the anomaly processing module are implemented by a single integrated circuit chip or implemented by a combination of multiple integrated circuit chips.

19. The optical module according to claim 13, wherein the first signal processing module and the second single processing module comprise physical layer interface chips as a client-side interface and a line-side interface, and an integrated circuit chip for implementing a protocol processing function, a forward error correction function, and a digital signal processing function, wherein the integrated circuit chip for implementing the protocol processing function, the forward error correction function, and the digital signal processing function is a single integrated circuit chip or a combination of multiple integrated circuit chips.

20. The optical module according to claim 19, wherein the first anomaly event comprises one or more of the following: an anomaly in a physical layer interface chip serving as the client-side interface, an anomaly in an alignment marker in the Ethernet data stream associated with the egress direction, and a forward error correction error rate in the Ethernet data stream associated with the egress direction higher than a preset level.

21. The optical module according to claim 19, wherein the second anomaly event comprises one or more of the following: an anomaly in a physical layer interface chip serving as the line-side interface, a decrease in power or signal-to-noise ratio of an optical signal carrying the optical communication data stream associated with the ingress direction, an anomaly in an equalizer in a digital signal processing function associated with the ingress direction, and a forward error correction error rate in the Ethernet data stream associated with the ingress direction higher than a preset level.

22. A method for processing a data transmission anomaly in an optical module-based communication process, wherein the optical module is configured to convert an Ethernet data stream associated with an egress direction into an optical communication data stream associated with the egress direction, and convert an optical communication data stream associated with an ingress direction into an Ethernet data stream associated with the ingress direction, the method comprising the following steps performed inside the optical module:
in response to a first anomaly event of data transmission associated with the egress direction, generating first indication information regarding the first anomaly event and inserting the first indication information into one or more of the following: the Ethernet data stream associated with the ingress direction, the Ethernet data stream associated with the egress direction, and the optical communication data stream associated with the egress direction, or
in response to a second anomaly event of data transmission associated with the ingress direction, generating second indication information regarding the second anomaly event and inserting the second indication information into one or more of the following: the Ethernet data stream associated with the egress direction, the Ethernet data stream associated with the ingress direction, and the optical communication data stream associated with the egress direction.

23. The method according to claim 22, wherein the first indication information or the second indication information is in the form of MAC messages, the MAC message comprising a custom field to describe features of the first anomaly event or the second anomaly event in one or more of the following dimensions: event type, event occurrence time, a port number assigned to the optical module involved in the anomaly event, and a parameter value involved in the anomaly event.

24. The optical module according to claim 23, wherein the first anomaly event is inserted in the following manner:
transmitting the first indication information immediately or in a preset period, after completion of transmission of the current service message included in the Ethernet data stream associated with the ingress direction; and
the second anomaly event is inserted in the following manner:
transmitting the second indication information immediately or in a preset period, after completion of transmission of the current service message included in the Ethernet data stream associated with the egress direction.

25. The method according to claim 24, wherein immediate transmission and transmission in a preset period of the first indication information and the second indication information are carried out in the following manner: inserting, via an xGMII interface, the first indication information and the second indication information in the form of MAC messages into the Ethernet data stream associated with the ingress direction and the Ethernet data stream associated with the egress direction.

26. The method according to claim 22, further comprising:
in response to recovery of data transmission associated with the egress direction or recovery of data transmission associated with the ingress direction, generating third indication information regarding the recovery and inserting the third indication information into one or more of the following: the Ethernet data stream associated with the ingress direction, the Ethernet data stream associated with the egress direction, and the optical communication data stream associated with the egress direction.

27. The method according to claim 22, wherein the first anomaly event comprises one or more of the following: an anomaly in a physical layer interface chip serving as a client-side interface, an anomaly in an alignment marker in the Ethernet data stream associated with the egress direction, and a forward error correction error rate in the Ethernet data stream associated with the egress direction higher than a preset level.

28. The method according to claim 22, wherein the second anomaly event comprises one or more of the following: an anomaly in a physical layer interface chip serving as a line-side interface, a decrease in power or signal-to-noise ratio of an optical signal carrying the optical communication data stream associated with the ingress direction, an anomaly in an equalizer in a digital signal processing function associated with the ingress direction, and a forward error correction error rate in the Ethernet data stream associated with the ingress direction higher than a preset level.
